(19) United States
(12) Patent Application Publication
(10) Pub. No.: US 2025/0037926 A1
(43) Pub. Date: Jan. 30, 2025

(54) TRANSFORMER FOR LOW VOLTAGE DC-DC CONVERTER OF ELECTRIC VEHICLE

(71) Applicant: Atum Co., Ltd., Ansan-si (KR)

(72) Inventor: Taeksoo HAN, Seoul (KR)

(21) Appl. No.: 18/777,533

(22) Filed: Jul. 18, 2024

(30) Foreign Application Priority Data
Jul. 27, 2023 (KR) 10-2023-0098536

(51) Int. Cl. H01F 27/28; B60L 1/00; H01F 27/29

(52) U.S. Cl. CPC H01F 27/2823; H01F 27/29; B60L 1/00; B60L 2210/10

(57) ABSTRACT

Provided relates to a transformer for a low voltage DC-DC converter (LDC) of an electric vehicle, the transformer including: a flat plate type primary coil for receiving current from a high-voltage battery of the electric vehicle; a lower secondary coil element located under the primary coil in such a way as to come into close contact with an underside of the primary coil and generate induced current by means of the current flowing to the primary coil to supply the generated induced current to electronic components of the electric vehicle; and an upper secondary coil element located above the primary coil in such a way as to come into close contact with a top of the primary coil and generate induced current by means of the current flowing to the primary coil to supply the generated induced current to the electronic components of the electric vehicle.

### BACKGROUND OF THE DISCLOSURE

### Cross Reference to Related Application of the Disclosure

The present application claims the benefit of Korean Patent Application No. 10-2023-0098536 filed in the Korean Intellectual Property Office on Jul. 27, 2024, the entire contents of which are incorporated herein by reference.

### FIELD OF THE DISCLOSURE

The present disclosure relates to a transformer for a low voltage DC-DC converter (LDC) of an electric vehicle.

### BACKGROUND OF THE RELATED ART

A plug-in hybrid electric vehicle (PHEV) and an electric vehicle (EV) (hereinafter, referred to collectively as electric vehicle) is provided with an on-board charger (OBC) for charging a high-voltage battery that drives the motor of the vehicle with commercial AC power (200V AC) supplied from an electric vehicle charger, the high-voltage battery charged with power converted by and supplied from the OBC, a low voltage DC-DC converter (LDC) for converting a high voltage of the high-voltage battery into a low voltage of 12V and supplying power to a low-voltage battery or electrical components of the electric vehicle.

In detail, the LDC built in the electric vehicle is a converter for converting power of the high-voltage battery into power of a 12V low voltage battery, and although most of the components (such as headlight, wipers, pumps, control boards, and the like) of the electric vehicle operate with 12V and an existing electric vehicle having an engine generates 12V as the engine functions as a generator, an electric vehicle requires a device for converting the high voltage charged in a high voltage battery into a low voltage, which is an operating voltage of electrical components.

The LDC built in an electric vehicle is configured to include a converter for converting DC voltage of a high voltage charger into high-frequency AC voltage through a full bridge circuit, an LDC transformer for converting the AC voltage of the converter into a low voltage and insulating the AC voltage from the high-voltage battery, and a rectifier for rectifying and smoothing the AC voltage and charging the low-voltage battery with the rectified AC voltage.

Here, the configuration of an LDC transformer according to the prior art will be described.

The LDC transformer according to the prior art includes a primary coil wound around a specially manufactured bobbin and a separate insulation casing for insulation between the wound primary coil and a secondary coil.

However, the transformer for the LDC of an electric vehicle according to the prior art has the following problems.

Firstly, the size of the conventional transformer for the LDC is considerably large. In detail, in the process of winding the primary coil around a specially designed bobbin, it is difficult to properly align portions of the primary coil wound, thereby causing the size of a primary coil product itself to increase, and as the primary coil is inserted in a separate double casing so that it is insulated from a secondary coil, further, the diameter and size of a transformer product itself increase, thereby causing the overall size of the transformer to increase.

In addition, a process of fixing the primary coil with fixing members is performed after the primary coil has been wound, and next, processes of inserting the secondary coil into the casing and inserting the primary coil into the casing where the secondary coil is inserted are performed. Like this, a large number of assembly processes for the transformer for the LDC are required, thereby undesirably lowering the productivity of the transformer.

Besides, as the primary coil is wound manually, portions of the primary coil wound are not aligned well, and thus, a loss increases, thereby lowering an efficiency thereof and making electromagnetic interference (EMI) shielding performance deteriorated badly.

### SUMMARY OF THE DISCLOSURE

Accordingly, the present disclosure has been made in view of the above-mentioned problems occurring in the related art, and it is an object of the present disclosure to provide a transformer for a low voltage DC-DC converter (LDC) of an electric vehicle that is capable of converting large current and high voltage, even while it is being simple in configuration and compact in size.

It is another object of the present disclosure to provide a transformer for an LDC of an electric vehicle that is capable of allowing a primary coil and secondary coil elements to be kept insulated from one another even at a high voltage in the range of several to tens of kV.

It is yet another object of the present disclosure to provide a transformer for an LDC of an electric vehicle that is capable of allowing a loss between a primary coil and secondary coil elements to be decreased, thereby enhancing efficiencies therebetween.

It is still another object of the present disclosure to provide a transformer for an LDC of an electric vehicle that is capable of being reduced in height and size so that the space occupied by the LDC in the electric vehicle becomes small, thereby improving the product competitiveness of the LDC of the electric vehicle.

It is yet still another object of the present disclosure to provide a transformer for an LDC of an electric vehicle that is capable of reducing the number of assembling processes for a primary coil, thereby improving product productivity and price competitiveness.

It is another object of the present disclosure to provide a transformer for an LDC of an electric vehicle that is capable of improving heating characteristics and EMI shielding performance.

It is yet another object of the present disclosure to provide a transformer for an LDC of an electric vehicle that is capable of allowing secondary coil elements to be connected in series with each other under a simple configuration and ensuring contact reliability between terminals for the serial connection.

It is still another object of the present disclosure to provide a transformer for an LDC of an electric vehicle that is capable of being mounted easily and conveniently.

To accomplish the above-mentioned objects, according to the present disclosure, there is provided a transformer for a low voltage DC-DC converter (LDC) of an electric vehicle, the LDC of the electric vehicle being adapted to supply power supplied from a high-voltage battery of the electric vehicle to electronic components of the electric vehicle, the transformer including: a flat plate type primary coil for receiving current from the high-voltage battery of the electric vehicle; a lower secondary coil element located under the primary coil in such a way as to come into close contact with an underside of the primary coil and generate induced current by means of the current flowing to the primary coil to supply the generated induced current to the electronic components of the electric vehicle; and an upper secondary coil element located above the primary coil in such a way as to come into close contact with a top of the primary coil and generate induced current by means of the current flowing to the primary coil to supply the generated induced current to the electronic components of the electric vehicle, wherein the primary coil is formed of an adhesion type covered conductive wire made by covering an insulating tape as an outer covering on a conductive wire and applying an adhesive onto the outer peripheral surface of the insulating tape to form a bonding layer, and the primary coil is provided to the form of a hard coil by winding the adhesion type covered conductive wire in such a way as to have multiple turns by means of a winding member, while forming a first central hole C1 on a center thereof, fusing and curing the applied bonding layer, and joining and aligning the close contact portions of the adhesion type covered conductive wire by means of the fusing.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a transformer for an LDC of an electric vehicle according to the present disclosure;

FIG. 2 is a sectional view showing the transformer of FIG. 1;

FIG. 3 is an exploded perspective view showing the transformer of FIG. 1;

FIG. 4 is a bottom perspective side view showing the main components of the transformer of FIG. 3;

FIG. 5 is a perspective view showing the transformer for the LDC according to the present disclosure, in which magnetic cores are removed;

FIG. 6 is a plan view showing a primary coil of the transformer for the LDC according to the present disclosure;

FIG. 7A is a plan view showing a state where a lower copper sheet coil and an upper copper sheet coil are connected to each other in the transformer for the LDC according to the present disclosure;

FIG. 7B is an exploded perspective view showing the lower copper sheet coil and the upper copper sheet coil of the transformer for the LDC according to the present disclosure;

FIG. 8 is a plan view showing a variation of the primary coil of the transformer for the LDC according to the present disclosure;

FIG. 9A is a concept view showing a schematic outer shape of a thin copper wire of an adhesion type covered conductive wire for forming the primary coil according to the present disclosure;

FIG. 9B is a sectional view showing the adhesion type covered conductive wire for forming the primary coil of the transformer for the LDC according to the present disclosure; and

FIG. 9C is a concept view showing an outer shape of the adhesion type covered conductive wire of the primary coil of the transformer for the LDC according to the present disclosure, in which multiple thin copper wires are exposed to the outside.

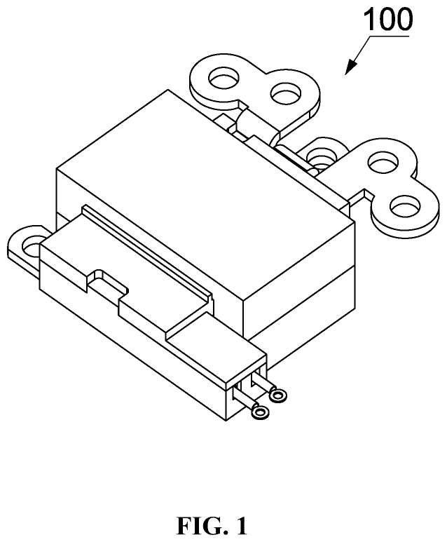

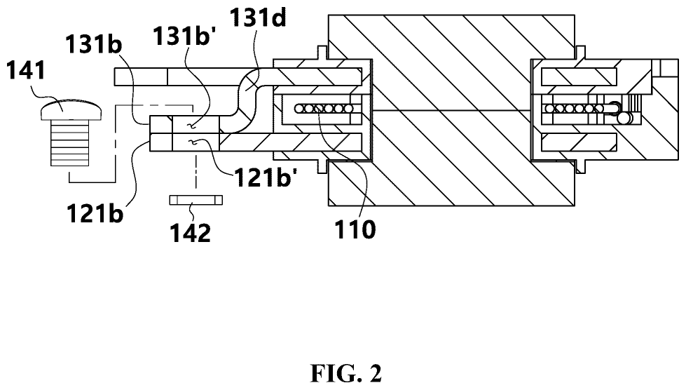

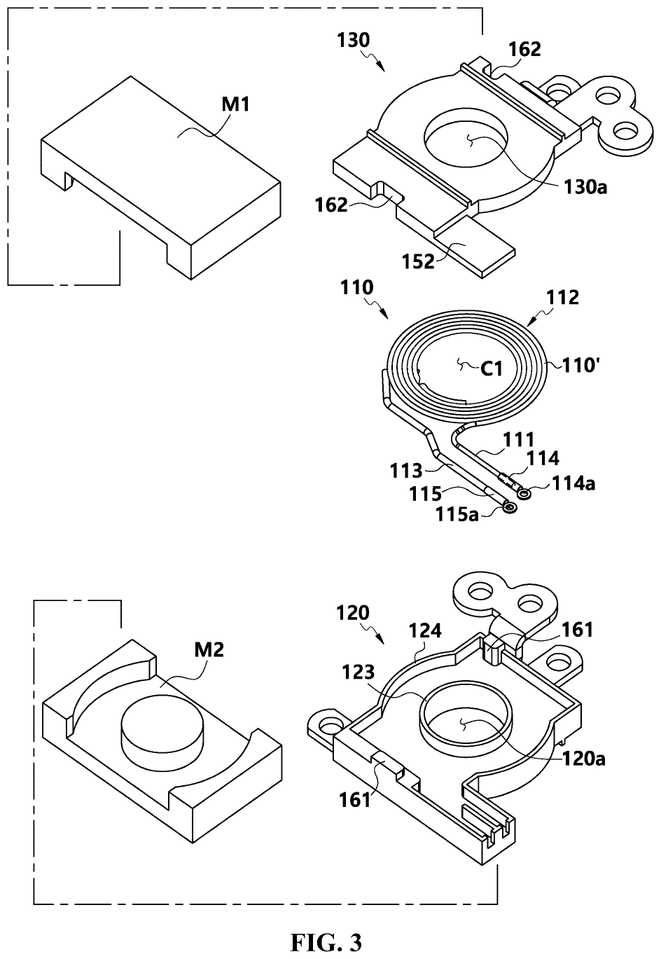

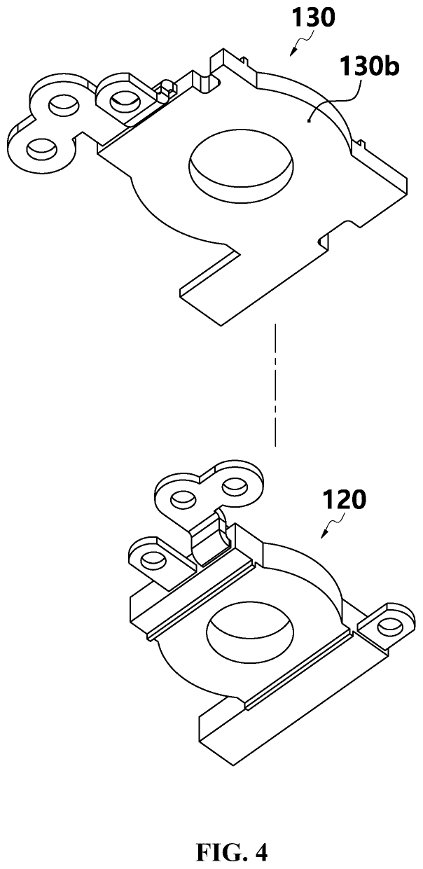

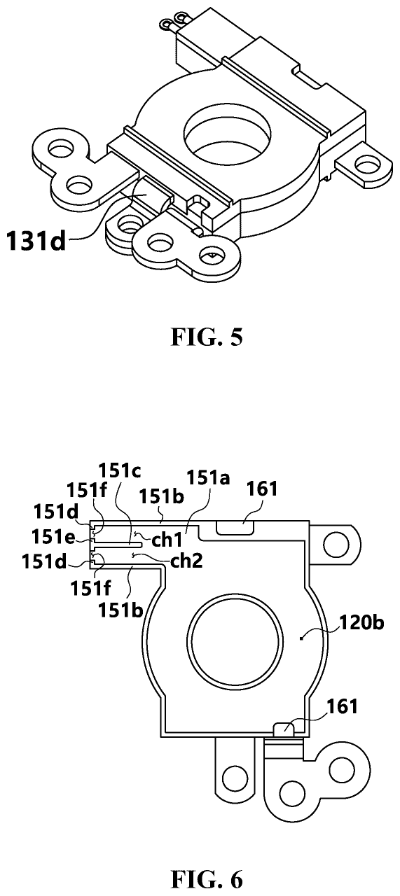

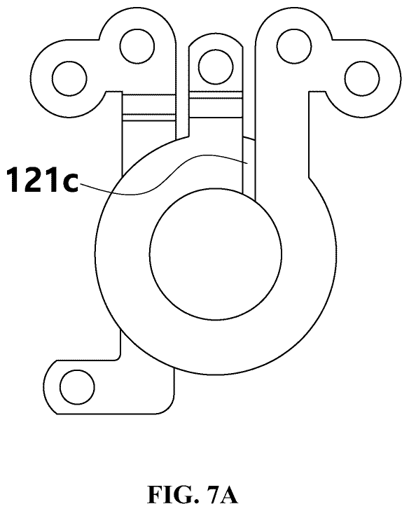

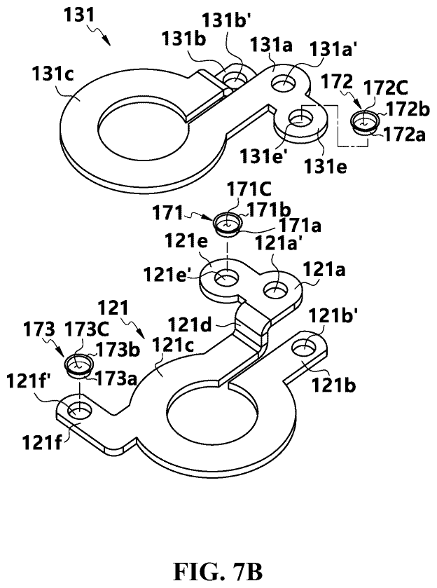

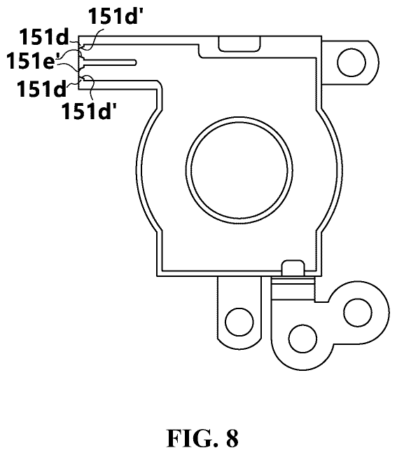

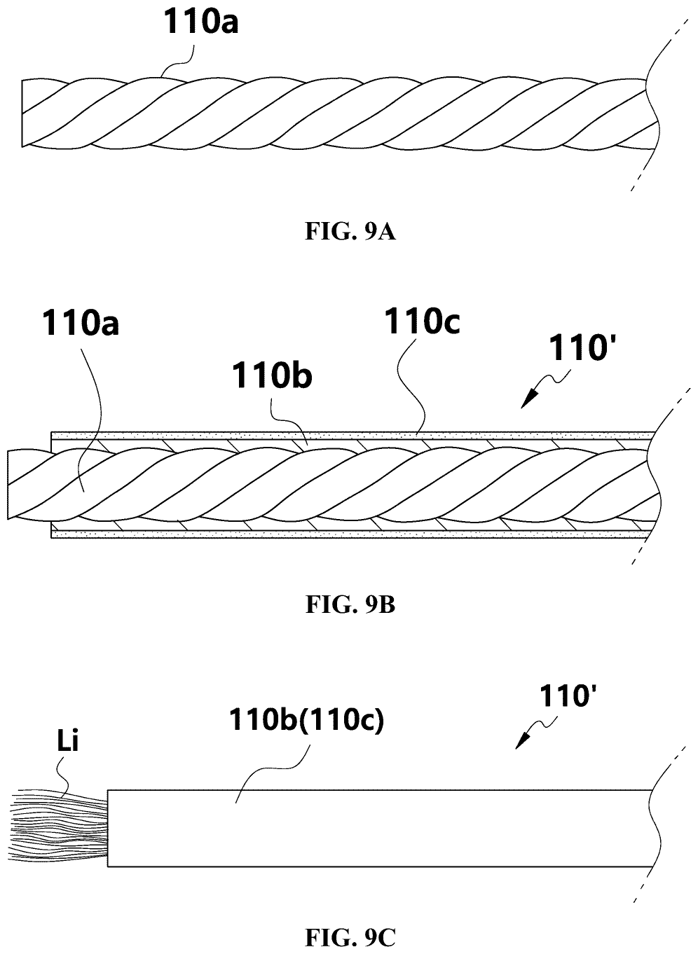

### DETAILED DESCRIPTION OF THE EMBODIMENTS

Hereinafter, an explanation of a transformer for an LDC of an electric vehicle according to an embodiment of the present disclosure will be given in detail with reference to the attached drawings.

According to the present disclosure, there is provided a transformer 100 for an LDC of an electric vehicle, the LDC of the electric vehicle being adapted to supply power supplied from a high-voltage battery of the electric vehicle to electronic components of the electric vehicle, the transformer 100 including: a flat plate type primary coil 110 for receiving current from the high-voltage battery of the electric vehicle; a lower secondary coil element 120 located under the primary coil 110 in such a way as to come into close contact with an underside of the primary coil 110 and generate induced current by means of the current flowing to the primary coil 110 to supply the generated induced current to the electronic components of the electric vehicle; and an upper secondary coil element 130 located above the primary coil 110 in such a way as to come into close contact with a top of the primary coil 110 and generate induced current by means of the current flowing to the primary coil 110 to supply the generated induced current to the electronic components of the electric vehicle.

Further, the primary coil 110 is formed of an adhesion type covered conductive wire 110′ made by covering an insulating tape 110b as an outer covering on a copper wire and applying (coating) an adhesive onto the outer peripheral surface of the insulating tape 110b to form a bonding layer 110c.

Further, the primary coil 110 is provided to the form of a hard coil by winding the adhesion type covered conductive wire 110′ in such a way as to have multiple turns by means of a winding member, while forming a first central hole C1 on a center thereof, fusing and curing the applied bonding layer 110c with a solvent (e.g., alcohol) or heat (hot air), and joining and aligning (without any irregular outer peripheral surfaces) the close contact portions of the adhesion type covered conductive wire 110′ by means of the fusing.

Accordingly, no insulation breakdown occurs even at a high voltage in the range of several to tens of kV, and a distance between the primary coil and the adjacent secondary coil element decreases, while a degree of contact therebetween is increasing, so that a loss therebetween is reduced to improve an efficiency therebetween.

The winding member is a winding jig or winder.

The adhesive is an adhesive paint.

The insulating tape 110b is a Kapton tape.

The primary coil 110 includes an input wire portion 111 connected to the high-voltage battery of the electric vehicle (especially to the converter of the LDC) and formed of the adhesion type covered conductive wire 110′ of a linear type, a primary coil wound portion 112 extending from the input wire portion 111 and formed by winding the adhesion type covered conductive wire 110′ in such a way as to have multiple turns in the form of a flat plate, while forming the first central hole C1 on the center thereof, and an output wire portion 113 formed of the adhesion type covered conductive wire 110′ of a linear type in such a way as to be connected from the end of the primary coil wound portion 112 to the high-voltage battery of the electric vehicle (especially to the converter of the LDC).

The primary coil wound portion 112 is formed in a hard state by automatically winding the adhesion type covered conductive wire 110′ to the form of the flat plate by means of the winding member so that the wound portions of the adhesion type covered conductive wire 110′ are brought into close contact with one another and simultaneously aligned in a horizontal direction and/or in a vertical direction (that is, in both horizontal and vertical directions or in either horizontal or vertical direction), fusing and curing the coated bonding layer 110b with a solvent (e.g., alcohol) or heat (hot air), and joining and aligning (without any irregular outer peripheral surfaces) the close contact portions of the adhesion type covered conductive wire 110′ by means of the fusing.

Under the above-mentioned configuration of the primary coil 110, accordingly, no insulation breakdown occurs even at a high voltage in the range of several to tens of kV, and the primary coil can supply large current and high voltage even if it is small in size.

Further, as the insulating tape 110b itself of the primary coil 110 of the transformer for the LDC is adhesively formed by means of the bonding layer 110c, the primary coil 110 itself has a high degree of contact, and further, the contact among the primary coil 110 and the secondary coil elements is improved, so that a loss thereamong is reduced to improve the efficiency thereamong. Further, the transformer as a product is reduced in height (to a height of 60% of the conventional transformer for the LDC) and in size (to a size of 55% of the conventional transformer for the LDC).

As the height and size of the transformer for the LDC are reduced, the LDC itself is decreased in size, so that the space occupied by the LDC in the electric vehicle becomes small, thereby improving the product competitiveness of the LDC of the electric vehicle.

Further, the primary coil 110 of the transformer for the LDC according to the present disclosure is made by means of a winding jig or winder, which makes it possible to automatedly produce the primary coil 110 of the transformer for the LDC, so that the number of assembling processes for the primary coil 110 is reduced (to 30% of the number of assembling processes for the conventional transformer for the LDC), thereby greatly improving its productivity and price competitiveness.

As there is no need to doubly adopt a bobbin and a casing for holding the primary coil, the transformer 100 for the LDC has excellent heating characteristics and high electromagnetic interference (EMI) shielding performance.

Furthermore, well-known conductive wires may be used freely as the copper wire covered with the insulating tape 110b.

That is, the copper wire for the primary coil 110 is a bare copper wire, a thin copper wire 110a made by twisting multi-stranded thin copper wires Li, or a bare copper wire or thin copper wire 110a onto which insulation coating is applied. In any case, such copper wires may be within the technical scope of the present disclosure.

The lower secondary coil element 120 includes a plate-shaped lower copper sheet coil 121 formed of a copper sheet having thickness and sectional area greater than non-flexible reference thickness and sectional area and a lower insulator 122 made of a synthetic resin, having a lower central hole 120a, and building the lower copper sheet coil 121 except lower terminals 121a and 121b therein.

The upper secondary coil element 130 includes a plate-shaped upper copper sheet coil 131 formed of a copper sheet having thickness and sectional area greater than non-flexible reference thickness and sectional area and an upper insulator 132 made of a synthetic resin, having an upper central hole 130a, and building the upper copper sheet coil 131 except upper terminals 131a and 131b therein.

In this case, the underside of the primary coil 110 comes into close contact with a top 120b of the lower secondary coil element 120 (that is, a top of the lower insulator 122), and the top of the primary coil 110 comes into close contact with an underside 130b of the upper secondary coil element 130 (that is, an underside of the upper insulator 132), so that the primary coil 110 is brought into close contact between the lower secondary coil element 120 and the upper secondary coil element 130.

Like this, the secondary coil elements are formed of such non-flexible thick copper sheets, thereby being advantageous in the conversion of large current and high voltage.

The lower copper sheet coil 121 includes the lower first terminal 121a having a terminal hole 121a′ formed thereon, a downward bent portion 121d vertically bent downward from the lower first terminal 121a, a lower wound portion 121c bent vertically from the end of the downward bent portion 121d in such a way as to have a single turn in a horizontal direction, and the lower second terminal 121b extending horizontally from the end of the lower wound portion 121c and having a terminal hole 121b′ formed thereon.

The upper copper sheet coil 131 includes the upper first terminal 131a having a terminal hole 131a′ formed thereon, an upper wound portion 131c extending horizontally from the upper first terminal 131a in such a way as to have a single turn, an upward bent portion 131d vertically bent upward from the end of the upper wound portion 131c, and the upper second terminal 131b vertically bent from the end of the upward bent portion 131d in such a way as to extend horizontally and having a terminal hole 131b′ formed thereon.

If the primary coil 110 is brought into close contact between the lower secondary coil element 120 and the upper secondary coil element 130, further, the formation of the lower second terminal 121b, the upper second terminal 131b, and the downward bent portion 121d allows the terminal hole 121b′ of the lower second terminal 121b to communicate with the terminal hole 131b′ of the upper second terminal 131b and allows the lower second terminal 121b and the upper second terminal 131b to have surface contact with each other on the same position as each other with respect to upward and downward directions (in a height direction), and the formation of the lower first terminal 121a, the upper first terminal 131a, and the upward bent portion 131d allows the lower first terminal 121a and the upper first terminal 131a to be located on the same position as each other with respect to a horizontal direction.

Accordingly, the height and size of the transformer 100 are reduced.

Under the above-mentioned simple configuration, further, the secondary coil elements are connected in series with each other, and besides, the terminals for the serial connection have surface contact with each other, thereby ensuring the reliability in the serial connection.

The transformer 100 for the LDC of the electric vehicle according to the embodiment of the present disclosure further includes fastening members 141 and 142 fastened to the terminal hole 121b′ of the lower second terminal 121b and the terminal hole 131b′ of the upper second terminal 131b in such a way as to allow the lower second terminal 121b and the upper second terminal 131b to have surface contact with each other, while preventing a gap therebetween from occurring.

Accordingly, no gap between the lower second terminal 121b and the upper second terminal 131b occurs, thereby more reliably achieving the surface contact therebetween.

The fastening member 141 is a fastening bolt inserted into both of the terminal hole 121b′ of the lower second terminal 121b and the terminal hole 131b′ of the upper second terminal 131b, and the fastening member 142 is a fastening nut fastened to the fastening bolt 141 exposed down from the terminal hole 121b′ of the lower second terminal 121b and the terminal hole 131b′ of the upper second terminal 131b.

In the transformer 100 for the LDC of the electric vehicle according to the embodiment of the present disclosure, the lower copper sheet coil 121 further includes a lower mounting portion 121e extending outward from the center of the lower first terminal 121a and having a lower mounting hole 121e′ formed thereon and the upper copper sheet coil 131 further includes an upper mounting portion 131e extending outward from the center of the upper first terminal 131a and having an upper mounting hole 131e′ formed thereon.

Accordingly, as the mounting portions 131e and 131e are formed on the terminals of the lower copper sheet coil and the upper copper sheet coil, without any separate mounting members, the process of mounting the transformer 100 for the LDC is performed easily and conveniently, and further, the transformer product itself becomes more compact.

In the transformer 100 for the LDC of the electric vehicle according to the embodiment of the present disclosure, the lower copper sheet coil 121 further includes a bottom mounting portion 121f extending horizontally from one side of the lower wound portion 121c and having a bottom mounting hole 121f formed thereon.

Accordingly, the transformer 100 for the LDC is directly mountable on the LDC casing itself, thereby preventing the transformer product from being vibrated or moving to thus ensure stable mounting.

A lower mounting member (not shown) (e.g., a mounting pin or bolt) is fastened to the lower mounting hole 121e′, an upper mounting member (not shown) (e.g., a mounting pin or bolt) is fastened to the upper mounting hole 131e′, and a bottom mounting member (not shown) (e.g., a mounting pin or bolt) is fastened to the bottom mounting hole 121f.

The transformer 100 for the LDC of the electric vehicle according to the embodiment of the present disclosure further includes a first insulating ring 171 fittedly fastened to the lower mounting hole 121e′ of the lower mounting portion 121e to insulate the lower mounting member from the lower copper sheet coil 121 and a second insulating ring 172 fittedly fastened to the upper mounting hole 131e′ of the upper mounting portion 131e to insulate the upper mounting member from the upper copper sheet coil 131.

Further, the transformer 100 for the LDC of the electric vehicle according to the embodiment of the present disclosure includes a third insulating ring 173 fittedly fastened to the bottom mounting hole 121f of the bottom mounting portion 121f to insulate the bottom mounting member from the lower copper sheet coil 121.

In detail, the first insulating ring 171 has a first body 171a fittedly fastened to the lower mounting hole 121e′ and having a first fastening hole 171c passing therethrough and a first flange 171b formed on the outer periphery of a top of the first body 171a in such a way as to be locked onto a top of the lower mounting portion 121e.

In the same manner, the second insulating ring 172 has a second body 172a fittedly fastened to the upper mounting hole 131e′ and having a second fastening hole 172c passing therethrough and a second flange 172b formed on the outer periphery of a top of the second body 172a in such a way as to be locked onto a top of the upper mounting portion 131e.

The third insulating ring 173 has a third body 173a fittedly fastened to the bottom mounting hole 121f and having a third fastening hole 173c passing therethrough and a third flange 173b formed on the outer periphery of a top of the third body 173a in such a way as to be locked onto a top of the bottom mounting portion 121f.

The transformer 100 for the LDC of the electric vehicle according to the embodiment of the present disclosure further includes a wiring guider 151 extending from the lower insulator 122 in such a way as to allow the first input wire portion 111 and the first output wire portion 113 to be stably arranged, without any disconnection, and a wiring cover 152 extending from the upper insulator 132, having shape matching with the wiring guider 151, covering the wiring guider 151, and pressingly protecting the first input wire portion 111 and the first output wire portion 113 arranged in the wiring guider 151.

Accordingly, the first input wire portion 111 and the first output wire portion 113 are protected from disconnection, so that they are stably wired in a neat manner.

In the transformer 100 for the LDC of the electric vehicle according to the embodiment of the present disclosure, the wiring guider 151 includes a bottom portion 151a extending from the lower insulator 122, a pair of outer ribs 151b protruding upward from the bottom portion 151a in such a way as to be spaced apart from each other, and a partition rib 151c protruding upward from the bottom portion 151a between the outer ribs 151b in such a way as to separately divide the first input wire portion 111 and the first output wire portion 113 from each other, so that a first guide channel ch1 is formed by one outer rib 151b, the partition rib 151c, and the wiring cover 152 in such a way as to guide the insertion of the first input wire portion 111 and stably seat and arrange the first input wire portion 111, and a second guide channel ch2 is formed by the other outer rib 151b, the partition rib 151c, and the wiring cover 152 in such a way as to guide the insertion of the first output wire portion 113 and stably seat and arrange the first output wire portion 113.

Accordingly, the first input wire portion 111 and the first output wire portion 113 are arranged more stably.

In the transformer 100 for the LDC of the electric vehicle according to the embodiment of the present disclosure, the wiring guider 151 further includes outer protrusions 151d protruding from the ends of the outer ribs 151b in a vertical direction with respect to a wiring direction (longitudinal direction) and partition protrusions 151d protruding from the end of the partition rib 151c in the vertical direction with respect to the wiring direction (longitudinal direction) in such a way as to be spaced apart from the outer protrusions 151d, and fitting holes 151f formed between the outer protrusions 151d and the partition protrusions 151e, respectively, in such a way as to hold the first input wire portion 111 and the first output wire portion 113 therein.

Accordingly, the first input wire portion 111 and the first output wire portion 113 are firmly held by means of the fitting holes 151f, thereby being preventing from having a gap or movement.

The outer protrusions 151d have slant guide surfaces 151d′ inclined narrow inward therefrom in such a way as to smoothly guide the first input wire portion 111 and the first output wire portion 113 to the fitting holes 151f, and the partition protrusions 151e have slant guide surfaces 151e′ inclined narrow inward therefrom in such a way as to smoothly guide the first input wire portion 111 and the first output wire portion 113 to the fitting holes 151f.

Accordingly, the first input wire portion 111 and the first output wire portion 113 are guided to the fitting holes 151f more easily and conveniently so that they are guided to and arranged in the first and second guide channels ch1 and ch2.

In the transformer 100 for the LDC of the electric vehicle according to the embodiment of the present disclosure, the lower insulator 122 further includes a positioning protrusion 161 protruding upward from at least one position thereof, and the upper insulator 132 further includes a positioning concave groove 162 formed thereon in such a way as to insert the positioning protrusion 161 thereinto.

In the transformer 100 for the LDC of the electric vehicle according to the embodiment of the present disclosure, as the top 120b of the lower secondary coil element 120 and the underside 130b of the upper secondary coil element 130 are flat surfaces, the lower secondary coil element 120 has outer protrusion edges 124 protruding upward from the lower insulator 122 along the outer edges of the top 120 in such a way as to hold the outer periphery of the primary coil 110 brought into close contact between the top 120b of the lower secondary coil element 120 and the underside 130b of the upper secondary coil element 130 and an inner protrusion edge 123 brought into close contact with the inner peripheral surface of the first central hole C1 of the primary coil 110 in such a way as to hold the inner peripheral surface of the first central hole C1 of the primary coil 110.

Desirably, as shown, the inner protrusion edge 123 protrudes from the inner peripheral surface of the first central hole 210a.

Further, the outer protrusion edges 124 and the inner protrusion edge 123 serve to hold the primary coil 110 to allow the primary coil 100 to be located on the same position as the upper and lower copper sheet coils 131 and 121 (that is, on the position where the centers are aligned in upward and downward directions), so that the center of the primary coil 110 is aligned with the centers of the upper and lower copper sheet coils 131 and 121, without being eccentric with respect to them.

Desirably, the upper secondary coil element 130 serves to push the primary coil 110 thereagainst, thereby preventing the primary coil 110 from having a gap or movement.

The lower insulator 122 is made by inserting the lower copper sheet coil 121 into an injection mold and performing insert molding for the lower copper sheet coil 121 by means of resin injection, and the upper insulator 132 is made by inserting the upper copper sheet coil 131 into an injection mold and performing insert molding for the upper copper sheet coil 131 by means of resin injection.

That is, the lower insulator 122 and the upper insulator 132 are made by inserting the lower copper sheet coil 121 and the upper copper sheet coil 131 into injection molds and performing insert molding for the lower copper sheet coil 121 and the upper copper sheet coil 131 by means of resin injection.

Desirably, the inner protrusion edge 123 and the outer protrusion edges 124 are formed unitarily with the lower insulator 122 by means of the insert molding.

As a result, advantageously, the inner protrusion edge 123, the outer protrusion edges 124, and the lower insulator 122 are simultaneously made by means of one-time injection.

In the transformer 100 for the LDC of the electric vehicle according to the embodiment of the present disclosure, the lower copper sheet coil 121 and the upper copper sheet coil 131 are formed by winding the copper sheets having thickness and sectional area greater than non-flexible reference thickness and sectional area in such a way as to have a single turn.

Desirably, the lower copper sheet coil 121 and the upper copper sheet coil 131 have a thickness in the range of 1.8 to 2.2 mm.

More desirably, the lower copper sheet coil 121 and the upper copper sheet coil 131 have a thickness of 2.0 mm.

In the transformer 100 for the LDC of the electric vehicle according to the embodiment of the present disclosure, the primary coil 140 is wound to allow the input wire portion 111 and the output wire portion 113 to be arranged toward the high-voltage battery of the electric vehicle in the same direction as each other.

The transformer 100 for the LDC of the electric vehicle according to the embodiment of the present disclosure further includes an upper magnetic core M1 located on top of the upper secondary coil element 130 and a lower magnetic core M2 located on an underside of the lower secondary coil element 120.

As described above, the transformer 100 for the LDC of the electric vehicle according to the embodiments of the present disclosure has the following advantages.

Firstly, the transformer can convert large current and high voltage, even while it is being simple in configuration and compact in size.

Secondly, the primary coil and the secondary coil elements can be kept insulated from one another even at a high voltage in the range of several to tens of kV.

Thirdly, a loss between the primary coil and the secondary coil elements can be decreased, thereby enhancing efficiencies therebetween.

Fourthly, the height and size of the transformer for the LDC can be reduced, so that the space occupied by the LDC in the electric vehicle becomes small, thereby improving the product competitiveness of the LDC of the electric vehicle.

Fifthly, the number of assembling processes for the primary coil can be reduced, thereby improving product productivity and price competitiveness.

Sixthly, heating characteristics and EMI shielding performance can be improved.

Seventhly, the secondary coil elements can be connected in series with each other under a simple configuration, and besides, contact reliability between the terminals for the serial connection can be ensured.

Lastly, the transformer for LDC can be mounted easily and conveniently.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

It is therefore intended that the scope of the invention be limited not by this detailed description, but rather by the claims appended hereto.

What is claimed is:

1. A transformer (100) for a low voltage DC-DC converter (LDC) of an electric vehicle, the LDC of the electric vehicle being adapted to supply power supplied from a high-voltage battery of the electric vehicle to electronic components of the electric vehicle, the transformer (100) comprising:
a flat plate type primary coil (110) for receiving current from the high-voltage battery of the electric vehicle;
a lower secondary coil element (120) located under the primary coil (110) in such a way as to come into close contact with an underside of the primary coil (110) and generate induced current by means of the current flowing to the primary coil (110) to supply the generated induced current to the electronic components of the electric vehicle; and
an upper secondary coil element (130) located above the primary coil (110) in such a way as to come into close contact with a top of the primary coil (110) and generate induced current by means of the current flowing to the primary coil (110) to supply the generated induced current to the electronic components of the electric vehicle,
wherein the primary coil (110) is formed of an adhesion type covered conductive wire (110′) made by covering an insulating tape 110b as an outer covering on a conductive wire and applying an adhesive onto the outer peripheral surface of the insulating tape (110b) to form a bonding layer (110c), and the primary coil (110) is provided to the form of a hard coil by winding the adhesion type covered conductive wire (110′) in such a way as to have multiple turns by means of a winding member, while forming a first central hole (C1) on a center thereof, fusing and curing the applied bonding layer (110c), and joining and aligning the close contact portions of the adhesion type covered conductive wire (110′) by means of the fusing.

2. The transformer according to claim 1, wherein the primary coil (110) comprises:
an input wire portion (111) connected to the high-voltage battery of the electric vehicle and formed of the adhesion type covered conductive wire (110′) of a linear type;
a primary coil wound portion (112) extending from the input wire portion (111) and formed by winding the adhesion type covered conductive wire (110′) in such a way as to have multiple turns in the form of a flat plate, while forming the first central hole (C1) on the center thereof; and
an output wire portion (113) formed of the adhesion type covered conductive wire (110′) of a linear type in such a way as to be connected from the end of the primary coil wound portion (112) to the high-voltage battery of the electric vehicle,
whereby the primary coil wound portion (112) is formed in a hard state by automatically winding the adhesion type covered conductive wire (110′) to the form of the flat plate by means of the winding member so that the wound portions of the adhesion type covered conductive wire (110′) are brought into close contact with one another and simultaneously aligned in a horizontal direction and/or in a vertical direction, fusing and curing the coated bonding layer (110b), and joining and aligning the close contact portions of the adhesion type covered conductive wire (110′) by means of the fusing.

3. The transformer according to claim 1, wherein the lower secondary coil element (120) comprises:
a lower copper sheet coil (121) formed of a non-flexible copper sheet; and
a lower insulator (122) made of a synthetic resin, having a lower central hole (120a), and building the lower copper sheet coil (121) except lower terminals (121a and 121b) therein; and
the upper secondary coil element (130) comprises:
an upper copper sheet coil (131) formed of a non-flexible copper sheet; and
an upper insulator (132) made of a synthetic resin, having an upper central hole (130a), and building the upper copper sheet coil (131) except upper terminals (131a and 131b) therein,
whereby the underside of the primary coil (110) comes into close contact with a top (120b) of the lower secondary coil element (120), and the top of the primary coil (110) comes into close contact with an underside (130b) of the upper secondary coil element (130), so that the primary coil (110) is brought into close contact between the lower secondary coil element (120) and the upper secondary coil element (130).

4. The transformer according to claim 3, wherein the lower copper sheet coil (121) comprises:
the lower first terminal (121a) having a terminal hole (121a′) formed thereon;
a downward bent portion (121d) vertically bent downward from the lower first terminal (121a);
a lower wound portion (121c) bent vertically from the end of the downward bent portion (121d) in such a way as to have a single turn in a horizontal direction; and
the lower second terminal (121b) extending horizontally from the end of the lower wound portion (121c) and having a terminal hole (121b′) formed thereon, and
the upper copper sheet coil (131) comprises:
the upper first terminal (131a) having a terminal hole (131a′) formed thereon;
an upper wound portion (131c) extending horizontally from the upper first terminal (131a) in such a way as to have a single turn;
an upward bent portion (131d) vertically bent upward from the end of the upper wound portion (131c); and
the upper second terminal (131b) vertically bent from the end of the upward bent portion (131d) in such a way as to extend horizontally and having a terminal hole (131b′) formed thereon,
whereby if the primary coil (110) is brought into close contact between the lower secondary coil element (120) and the upper secondary coil element (130), the formation of the lower second terminal (121b), the upper second terminal (131b), and the downward bent portion (121d) allows the terminal hole (121b′) of the lower second terminal (121b) to communicate with the terminal hole (131b′) of the upper second terminal (131b) and allows the lower second terminal (121b) and the upper second terminal (131b) to have surface contact with each other on the same position as each other with respect to upward and downward directions, and the formation of the lower first terminal (121a), the upper first terminal (131a), and the upward bent portion (131d) allows the lower first terminal (121a) and the upper first terminal (131a) to be located on the same position as each other with respect to a horizontal direction.

5. The transformer according to claim 4, further comprising fastening members (141 and 142) fastened to the terminal hole (121b′) of the lower second terminal (121b) and the terminal hole (131b′) of the upper second terminal (131b) in such a way as to allow the lower second terminal (121b) and the upper second terminal (131b) to have surface contact with each other, while preventing a gap therebetween from occurring.

6. The transformer according to claim 4, wherein the lower copper sheet coil (121) further comprises a lower mounting portion (121e) extending outward from the center of the lower first terminal (121a) and having a lower mounting hole (121e′) formed thereon and the upper copper sheet coil (131) further comprises an upper mounting portion (131e) extending outward from the center of the upper first terminal (131a) and having an upper mounting hole (131e′) formed thereon.

7. The transformer according to claim 4, wherein the lower copper sheet coil (121) further comprises a bottom mounting portion (121f) extending horizontally from one side of the lower wound portion (121c) and having a bottom mounting hole (121f′) formed thereon.

8. The transformer according to claim 6, further comprising:
a first insulating ring (171) fittedly fastened to the lower mounting hole (121e′) of the lower mounting portion (121e) to insulate a lower mounting member fastened to the lower mounting hole (121e′) from the lower copper sheet coil (121); and
a second insulating ring (172) fittedly fastened to the upper mounting hole (131e′) of the upper mounting portion (131e) to insulate an upper mounting member fastened to the upper mounting hole (131e′) from the upper copper sheet coil (131).

9. The transformer according to claim 3, further comprising:
a wiring guider (151) extending from the lower insulator (122) in such a way as to allow the first input wire portion (111) and the first output wire portion (113) to be stably arranged, without any disconnection; and
a wiring cover (152) extending from the upper insulator (132), having shape matching with the wiring guider (151), covering the wiring guider (151), and pressingly protecting the first input wire portion (111) and the first output wire portion (113) arranged in the wiring guider (151).

10. The transformer according to claim 9, wherein the wiring guider (151) comprises:
a bottom portion (151a) extending from the lower insulator (122);
a pair of outer ribs (151b) protruding upward from the bottom portion (151a) in such a way as to be spaced apart from each other; and
a partition rib (151c) protruding upward from the bottom portion (151a) between the outer ribs (151b) in such a way as to separately divide the first input wire portion (111) and the first output wire portion (113) from each other,
whereby a first guide channel (ch1) is formed by one outer rib (151b), the partition rib (151c), and the wiring cover (152) in such a way as to guide the insertion of the first input wire portion (111) and stably seat and arrange the first input wire portion (111), and a second guide channel (ch2) is formed by the other outer rib (151b), the partition rib (151c), and the wiring cover (152) in such a way as to guide the insertion of the first output wire portion (113) and stably seat and arrange the first output wire portion (113).
